(19) United States
(12) Patent Application Publication
(10) Pub. No.: US 2007/0200098 A1
(43) Pub. Date: Aug. 30, 2007

(54) Electrically Conducting Resin Composition And Container For Transporting Semiconductor-Related Parts

(76) Inventors: Yuji Nagao, Kanagawa (JP); Ryuji Yamamoto, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/592,121

(22) PCT Filed: Apr. 11, 2005
(86) PCT No.: PCT/JP05/07351

§ 371 Date: Sep. 8, 2006

Related U.S. Application Data
(60) Provisional application No. 60/562,249, filed on Apr. 15, 2004.

(30) Foreign Application Priority Data
Apr. 12, 2004 (JP) 2004-116321

(51) Int. Cl. H01B 1/12

(52) U.S. Cl. 252/500

(57) ABSTRACT

The present invention relates to an electrically conductive resin composition comprising a vapor grown carbon fiber (A1) having an outer fiber diameter of 80 to 500 nm and a resin (B), characterized in that: (1) the vapor grown carbon fiber (A1) has an interlayer spacing (d₀₀₂) of 0.345 nm or less and an aspect ratio of 40 to 1,000, (2) the ratio by volume of the vapor grown carbon fiber (A1) to the resin (B) (i.e., A1/B) is 0.5/99.5 to 12/88, (3) the electrically conductive resin composition has a volume resistivity value of 10⁵ Ωcm or less, and (4) when the resin composition is heated at 80° C. for 30 minutes, the total amount of gases generated therefrom is 5 ppm or less. The present invention also relates to a resin molded product comprising the electrically conductive composition. The electrically conductive resin composition suppresses deposition of a molecular contaminant generated from a resin material onto the surface of a packaged device product. The electrically conductive resin composition of the prevent invention can prevent deterioration of the quality of the product during transportation in the container produced by molding the composition for transporting an electronics-related parts, which leads to reduction of the yield of a final product; and enables washing or thermal drying of a carrier containing electronic parts.

### CROSS-REFERENCE TO THE RELATED APPLICATIONS

This is an application filed pursuant to 35 U.S.C. Section 111(a) with claiming the benefit of U.S. Provisional application Ser. No. 60/562,249 filed Apr. 15, 2004 under the provision of 35 U.S.C. Section 111(b), pursuant to 35 U.S.C. Section 119(e) (1).

### TECHNICAL FIELD

The present invention relates to an electrically conductive resin composition containing a vapor grown carbon fiber and a resin that generates only a small amount of gas. Specifically, the present invention relates to a resin composition which exhibits low water absorbability; suppresses generation of organic gas (contaminant) or moisture from a resin material such as a carrier or a casing for transporting IC chips, wafers or hard disks used in electronic devices and a packaging material; prevents reduction of the yield of a final product or deterioration of the quality of the product during the course of storage or transportation of the product; and enhances the reliability of the product. The present invention also relates to a container produced from the resin composition for transporting electronics-related parts, and to a packaging material produced from the resin composition.

### BACKGROUND ART

Conventionally, an injection tray, a vacuum-molded tray, a magazine, an embossed carrier tape or the like has been used for packaging an integrated circuit (IC) or an electronic part employing an IC. As electronic parts such as semiconductors have come to be miniaturized while exhibiting enhanced performance, the production environment of the parts, or contaminants which are generated during the course of storage or transportation of the parts and are brought into contact with the parts, have come to greatly affect the yield, quality or reliability of a final product.

The resin material for a package used for transporting or storing electronic parts is subjected to, for example, the following treatments: (1) an antistatic agent is applied to the surface of the packaging container, (2) an electrically conductive coating material is applied to the packaging container, or (3) an antistatic agent or an electrically conductive filler is dispersed in the resin material, so as to prevent breakage of the electronic part due to static electricity.

However, treatment (1) incurrs a problem that, though the packaging container exhibits satisfactory antistatic effects immediately after application of the antistatic agent, is used for a long period of time, the antistatic agent tends to be removed from the container due to moisture or wear, and thus the container fails to exhibit reliable performance. In addition, the packaging container, which exhibits a surface resistivity value of about 10⁹ to about 10¹²Ω, is not suitable for use for packaging an electronic parts that require sufficient antistatic effects. Treatment (2) involves problems in that, since an electrically conductive coating material tends to be non-uniformly applied to the packaging container during production, and the coating material is readily removed from the container due to wear, the container loses its antistatic effects, leading to breakage of the electronic part and contamination of a lead portion of the electronic part with the coating material. Treatment (3) involves problems in that, since a large amount of an antistatic agent must be added to the resin material, physical properties of the resin material deteriorate, and thus the surface resistivity value of the packaging container is greatly affected by humidity, and the container fails to exhibit reliable performance.

For the electrically conductive filler to be added to the resin material, fine metallic powder, carbon fiber, and carbon black or the like is employed (see, for example, JP-A-8-283584). Of these, fine metallic powder or carbon fiber, even when added to the resin material in only a small amount, provides the resin material with sufficient electrical conductivity. However, such metallic powder or carbon fiber considerably deteriorates the moldability of the resin material, and is difficult to be uniformly dispersed in the resin material. Further, a skin layer containing only the resin component is readily formed on the surface of the packaging container (molded product), and the packaging container fails to attain a constant surface resistivity value.

In contrast, carbon black can be uniformly dispersed in the resin material by controlling, for example, kneading conditions, and thus a constant surface resistivity value of the packaging container is readily obtained. Therefore, carbon black is generally employed as an electrically conductive filler. However, carbon black, which must be added to the resin material in a large amount, may deteriorate the fluidity or moldability of the resin material. As has been reported in recent years, molecular contaminants greatly affect characteristics of devices or raise problems during the course of production of the devices. Examples of such molecular contaminants include organic substances contained in air, including hydrocarbon compounds discharged from automobiles or factories; various organic substances contained in agricultural chemicals and the like; organic gases generated from the floor, wall and filter of a clean room, or from coatings and adhesives employed in the clean room; vapors of chemicals such as a detergent, an etchant and a lithography solution employed in apparatuses for a production process; and exhaled breath and sweat of operators.

Of these contaminants, micron-order contaminant particles have been reduced in number through provision of a clean room of high performance. However, contaminant particles having a size of nanometers or sub-nanometers have been found to adversely affect device characteristics.

In order to reduce generation of such molecular contaminants or contact of the contaminants with devices, attempts have been made to eliminate organic substances contained in air by providing a chemical filter or the like between a clean room and the outside, or between a step using an organic chemical and a step without using a chemical.

A variety of polymers are employed in production apparatuses in a clean room, and a wafer carrier or a casing is formed of such a polymer. Therefore, gases generated from a polymer become serious contaminants of devices. In order to solve such problems, attempts have been made to employ a packaging material and the like which generates neither gas nor fine particles.

In recent years, as an electrically conductive filler for solving the aforementioned problems, there have been proposed a variety of electrically conductive resin compositions containing carbon nanotube having a small fiber diameter (see, for example, JP-A-2000-113429 (WO01/078069) and JP-A-8-508534 (WO94/023433)).

Carbon nanotube is produced through, for example, arc discharge, laser evaporation or chemical vapor deposition. For example, in the case of arc discharge, discharge is generated between electrodes containing a metallic catalyst; carbon and the catalyst are evaporated at a temperature of 3,000° C. or higher; and, during the course of cooling thereof, carbon nanotube filaments are produced on the surface of particles of the metallic catalyst. In general, large amounts of the thus-produced carbon nanotube filaments are entangled with one another, and are collected as a sheet-like or lump-like mass of deposition.

The thus-obtained deposition product is difficult to disperse in a resin and the like. Therefore, generally, the deposition product is first subjected to preliminary treatment (milling) by use of a ball mill or a bead mill (see JP-A-2003-308734), followed by mixing the thus-milled product with a resin. Recently, there has also been proposed a technique in which such a deposition product is kneaded with and dispersed in a resin while the product is crushed by means of tribological crushing (solid-phase shear) (see JP-A-2002-347020). Meanwhile, as has been reported, when adding an electrically conductive filler, a filler containing particles having a high aspect ratio, even when the amount of the filler is small, enables to impart electrical conductivity to the resultant composition. Therefore, the aforementioned techniques involving preliminary treatment of carbon nanotube (i.e., cutting of carbon nanotube filaments) reduces the advantages of carbon nanotube, although the technique improves dispersibility of carbon nanotube in a resin.

Carbon nanotube having a small fiber diameter is produced at a low production yield (at most about 10 mass % on the basis of a raw material carbon). Furthermore, carbon nanotube produced through the aforementioned technique contains large amounts of impurities other than nanotube filaments such as soot (fine carbon particles) and a metallic catalyst. In general, such impurities need to be removed by treating the carbon nanotube with an acid or an oxidizing agent, followed by filtration, washing and drying of the resultant nanotube; or by evaporating the metallic catalyst at a temperature of 2,000° C. or higher. Therefore, the thus-produced carbon nanotube is over a hundred times as expensive as the vapor grown carbon fiber. Therefore, from the viewpoint of productivity and cost, progress in adoption of carbon nanotube for producing, for example, electrically conductive plastics has been very slow.

When the aforementioned resin composition is employed in a carrier, during the assembly process of a head of a hard disk and the like, in many cases, the head is washed and thermally dried while it is accommodated in the carrier. Therefore, the carrier is required not to contaminate or damage the head during the course of washing or thermal drying. Particularly, the carrier, which is exposed to a temperature higher than 120° C. during the course of drying, is required to have sufficient heat resistance to endure such a high drying temperature.

### DISCLOSURE OF THE INVENTION

Objects of the present invention are to provide an electrically conductive resin composition containing vapor grown carbon fiber and a resin that generates only a small amount of gas, which composition suppresses generation of organic gas (contaminant) or moisture from a resin material and deposition of a molecular contaminant onto the surface of a packaged device product; which prevents reduction of the yield of a final product or deterioration of the quality of the product during the course of storage or transportation; which enhances the reliability of the product; which enables washing or thermal drying of a carrier containing electronic parts; and which exhibits a constant volume resistivity value of 10⁵ Ωcm or less; as well as to provide a container for transporting electronics-related parts or semiconductor-related parts, such as a carrier or casing for transporting an IC chip, a wafer or a hard disk, the container being produced from the resin composition; and to provide a packaging material formed of the resin composition.

In order to attain the aforementioned objects, the present invention provides the following.

1. An electrically conductive resin composition comprising a vapor grown carbon fiber (A1) having an outer fiber diameter of 80 to 500 nm; and a resin (B), characterized in that:

(1) the vapor grown carbon fiber (A1) has an interlayer spacing (d₀₀₂) of 0.345 nm or less and an aspect ratio of 40 to 1,000,

(2) the ratio by volume of the vapor grown carbon fiber (A1) to the resin (B) (i.e., A1/B) is 0.5/99.5 to 12/88,

(3) the electrically conductive resin composition has a volume resistivity value of 10⁵ Ωcm or less, and

(4) when the resin composition is heated at 80° C. for 30 minutes, the total amount of gases generated therefrom is 5 ppm or less.

2. An electrically conductive resin composition comprising an electrically conductive filler containing a vapor grown carbon fiber (A1) having an outer fiber diameter of 80 to 500 nm, and fine carbon particles (A2); and a resin (B), characterized in that:

(1) the electrically conductive filler consists of the vapor grown carbon fiber (A1) having an interlayer spacing (d₀₀₂) of 0.345 nm or less and an aspect ratio of 40 to 1,000, and the fine carbon particles (A2) having a minor axis diameter of 1 to 500 nm and an aspect ratio of 5 or less,

(2) the ratio by volume of the electrically conductive filler to the resin (B) (i.e., (A1+A2)/B) is 0.5/99.5 to 12/88,

(3) the electrically conductive resin composition has a volume resistivity value of 10⁵ Ωcm or less, and

(4) when the resin composition is heated at 80° C. for 30 minutes, the total amount of gases generated therefrom is 5 ppm or less.

3. The electrically conductive resin composition according to 2 above, wherein the ratio by mass of the vapor grown carbon fiber (A1) to the fine carbon particles (A2) (i.e., A1/A2) is 5/95 to 95/5.

4. An electrically conductive resin composition comprising an electrically conductive filler containing a vapor grown carbon fiber (A1) having an outer fiber diameter of 80 to 500 nm, and fine carbon particles (A2); a resin (B); and an inorganic filler (C) having a particle size of 100 μm or less, characterized in that:

(1) the electrically conductive filler consists of the vapor grown carbon fiber (A1) having an interlayer spacing (d₀₀₂) of 0.345 nm or less and an aspect ratio of 40 to 1,000, and the fine carbon particles (A2) having a minor axis diameter of 1 to 500 nm and an aspect ratio of 5 or less,

(2) the ratio by volume of the electrically conductive filler to the resin (B) and the inorganic filler (C) (i.e., (A1+A2)/(B+C)) is 0.5/99.5 to 12/88,

(3) the electrically conductive resin composition has a volume resistivity value of 10⁵ Ωcm or less, and

(4) when the resin composition is heated at 80° C. for 30 minutes, the total amount of gases generated therefrom is 5 ppm or less.

5. The electrically conductive resin composition according to any one of 1 to 4 above, wherein the resin (B) contains at least one species selected from among polyethylene, polypropylene, polybutene, polymethylpentene, alicyclic polyolefin, aromatic polycarbonate, polybutylene terephthalate, polyethylene terephthalate, polyphenylene sulfide, polyether-imide, polysulfone, polyether-sulfone, polyether-ether-ketone, acrylic resin, styrenic resin, modified polyphenylene ether and liquid-crystalline polyester.

6. The electrically conductive resin composition according to 5 above, wherein the resin (B) contains at least one species selected from among polypropylene, aromatic polycarbonate, polyether-ether-ketone and modified polyphenylene ether.

7. The electrically conductive resin composition according to any one of 1 to 4 above, wherein the vapor grown carbon fiber (A1) has a BET specific surface area of 4 to 30 m²/g.

8. The electrically conductive resin composition according to any one of claim 1 to 4 above, wherein a percentage of water absorption is 0.2% or less, when immersed in distilled water of 23° C. for 24 hours.

9. A resin molded product comprising the electrically conductive resin composition described in any one of 1 to 8 above.

10. The resin molded product according to 9 above, which is a container or a packaging material for an electronic part.

11. The resin molded product according to 9 above, which is a container for transporting a semiconductor part or a hard disk.

12. The resin molded product according to 11 above, wherein the container for transporting a hard disk is employed for a hard disk head.

The present invention will next be described in more detail.

In the vapor grown carbon fiber (A1) employed in the present invention, which has an outer diameter of 80 to 500 nm (preferably 90 to 250 nm, more preferably 100 to 200 nm), (a) the aspect ratio is 40 to 1,000, preferably 50 to 500, more preferably 60 to 300; (b) the interlayer spacing (d₀₀₂) as measured through X-ray diffractometry is 0.345 nm or less, preferably 0.343 nm or less, more preferably 0.340 nm or less; and (c) the BET specific surface area is 4 to 30 m²/g, preferably 8 to 25 m²/g, more preferably 10 to 20 m²/g.

In the case where the outer diameter of the carbon fiber to be employed is less than 80 nm, the surface energy of the carbon fiber increases exponentially, and the cohesive force between filaments of the carbon fiber increases drastically. When a resin is kneaded with aggregating filaments of fine carbon fiber without any treatment of the filaments, the fiber filaments fail to be sufficiently dispersed in the resin serving as a matrix, and the aggregating fiber filaments are unevenly distributed in the resin matrix, and thus an electrically conductive network fails to be formed. In addition, pores contained in the aggregating fiber filaments cause cracking of the resultant product, which may lower the strength of the product. In order to reduce the amount of such aggregating filaments, and to make the fine carbon fiber filaments to be sufficiently dispersed in a resin, there is employed a method in which a strong shear force is applied during melt-kneading the carbon fiber filaments with the resin. This method breaks such aggregating fiber filaments and enables dispersion of fine carbon fiber filaments in a resin matrix. However, the fine carbon fiber itself is broken during breakage of the aggregating fiber filaments by this method. Therefore, without adding carbon fiber in an amount exceeding a predetermined level, desired electrical conductivity characteristics fail to be attained. In contrast, in the case where the outer diameter of the carbon fiber to be employed exceeds 500 nm, the surface smoothness of the resultant molded product is lowered, which may increase the risk of damage to a wafer and the like.

When vapor grown carbon fiber having an aspect ratio of less than 40 is employed, a large amount of the carbon fiber must be added to a resin, in order to form an electrically conductive network of the carbon fiber in the resultant resin molded product.

In contrast, when vapor grown carbon fiber having a high aspect ratio is employed, ideally, an electrically conductive network can be formed through addition of a small amount of the carbon fiber, which is preferred. However, in practice, when the aspect ratio of vapor grown carbon fiber is high; i.e., when the length of the carbon fiber is excessively large, interaction between filaments of the carbon fiber increases, and fluffy aggregating filaments are formed, whereby the carbon fiber is difficult to uniformly disperse in a resin. Therefore, in the case of the vapor grown carbon fiber employed in the present invention, the upper limit of the aspect ratio must be regulated to lower than about 1,000, which is said to be an aspect ratio of generally employed carbon fiber.

In order to increase the electrical conductivity of the resin composition, preferably, vapor grown carbon fiber exhibiting high crystallinity (i.e., vapor grown carbon fiber having a high d₀₀₂ value) is employed, since such carbon fiber per se exhibits high electrical conductivity. The d₀₀₂ of carbon fiber does not become less than 0.3354 nm, which is the theoretical value of graphite. In order to attain high crystallinity of carbon fiber, the d₀₀₂ of the carbon fiber must be maintained at 0.345 nm or less. However, when the outer diameter of carbon fiber is excessively small, even if the d₀₀₂ of the carbon fiber is maintained at 0.345 nm or less, the interlayer spacing may fail to be reduced due to the effect of the curvature of the carbon fiber.

The BET specific surface area of carbon fiber is generally correlated with the outer diameter of the carbon fiber. Specifically, the smaller the outer diameter of carbon fiber, the greater the BET specific surface area thereof. When the outer diameter of carbon fiber becomes smaller, the BET specific surface area thereof increases, and thus the surface energy of the carbon fiber increases. Therefore, the carbon fiber is difficult to be dispersed in a resin, and the carbon fiber fails to be completely coated with the resin. When an electrically conductive resin composition (composite material) is formed from carbon fiber of a small diameter, the resin composition exhibits lowered electrical conductivity and mechanical strength, which is not preferred.

As described above, the outer diameter, aspect ratio, BET specific surface area, and d₀₀₂ as measured through X-ray diffractometry (crystallinity) of the vapor grown carbon fiber employed in the present invention are determined on the basis of balance between the cohesive property, dispersibility, and electrical conductivity of the carbon fiber.

When a container for transporting semiconductor-related parts is produced from the resin composition, the ratio by volume of the vapor grown carbon fiber to the resin (i.e., vapor grown carbon fiber/resin) is regulated to 0.5/99.5 to 12/88, preferably 1/99 to 10/90, more preferably 2/98 to 8/92.

When the ratio by volume of the vapor grown carbon fiber to the resin is lower than 0.5/99.5, it develops difficulty in forming an electrically conductive network of the vapor grown carbon fiber, as well as the distribution state of the carbon fiber in the resin matrix is affected by a slight change in molding conditions. For example, in the case of injection molding of the resin composition, the distribution state of the carbon fiber in the molded product varies in accordance with pressure and temperature distributions, resulting in non-uniform surface resistance of the molded product. In contrast, when the ratio by volume of the vapor grown carbon fiber to the resin is higher than 12/88, the fluidity of the resin composition is lowered, and the surface roughness of the resultant carrier becomes large. In addition, the carbon fiber tends to be exposed on the surface of the carrier, and the thus-exposed fiber may cause problems such as scratching. The vapor grown carbon fiber to be employed may be “as-produced” carbon fiber, or carbon fiber which has undergone thermal treatment. If desired, the vapor grown carbon fiber may be subjected to oxidation treatment, treatment with boron, or surface treatment with, for example, a silane-, titanate-, aluminum- or phosphate-containing coupling agent.

The vapor grown carbon fiber to be employed may have a hollow space extending along its axis, or may have a branched structure.

In the fine carbon particles (A2) employed in the present invention, (a) the minor axis diameter is 1 to 500 nm, preferably 5 to 300 nm, more preferably 10 to 100 nm; (b) the aspect ratio is 5 or less, preferably 3 or less, more preferably 1 to 1.5; and (c) the bulk density is 0.001 g/cm³ or more, preferably 0.005 g/cm³ to 0.1 g/cm³ more preferably 0.01 g/cm³ to 0.05 g/cm³.

Similar to the case of the vapor grown carbon fiber, when the particle size of the fine carbon particles (A2) is excessively small, the surface energy of the particles increases exponentially, and the cohesive force between the particles increases drastically. When a resin is kneaded with the vapor grown carbon fiber and the aggregating particles without any treatment of the particles, the fine carbon particles fail to be sufficiently dispersed in the resin serving as a matrix, and the aggregating particles are unevenly distributed in the resin matrix, and thus an electrically conductive network fails to be sufficiently formed.

When the aspect ratio of the fine carbon particles is more than five, and the particle size distribution is broad, a particle tends to enter a space formed by adjacent particles, and packing of the particles proceeds. Since the packing density of the thus-packed particles is higher than that of an aggregation of low-aspect-ratio fine carbon particles, the packed particles are difficult to dissociate from one another.

When the bulk density of the fine carbon particles is lower than 0.001 g/cm³, it develops difficulty in kneading the particles with a resin for the preparation of the resin composition. That is, since the carbon particles are bulky and are not dense, they are not readily dispersed in a resin, and the amount of the particles added to the resin is difficult to control. In addition, it becomes increasingly difficult to remove pores present between the particles during the course of kneading.

The amounts of the vapor grown carbon fiber and the fine carbon particles to be added (in the present invention, the fiber and the particles are collectively referred to as an electrically conductive filler) are regulated such that the volume resistivity value of the resin composition becomes preferably 10¹ to 10⁵ Ωcm, more preferably 10² to 10⁴ Ωcm. The ratio by volume of the electrically conductive filler to the resin (i.e., electrically conductive filler/resin) is regulated to 0.5/99.5 to 12/88, preferably 1/99 to 10/90, more preferably 2/98 to 8/92.

The fine carbon particles may be employed without any treatment. If desired, the carbon particles may be subjected to thermal treatment, oxidation treatment, treatment with boron or surface treatment with, for example, a silane-, titanate-, aluminum- or phosphate-containing coupling agent.

The ratio by mass of the vapor grown carbon fiber to the fine carbon particles (i.e., vapor grown carbon fiber/fine carbon particles), which constitutes the electrically conductive filler, is 5/95 to 95/5, preferably 10/90 to 90/10, more preferably 20/80 to 80/20.

When the fine carbon particles are added to a composition containing the vapor grown carbon fiber and resin, the particles enter spaces formed by filaments of the carbon fiber, which makes an improvement in equable surface resistance.

However, when the ratio by mass of the vapor grown carbon fiber to the fine carbon particles is lower than 5/95, it becomes unavailable to sufficiently improve the distribution of the uniform surface resistance, and the amount of the fine carbon particles becomes more than 6% by volume on the basis of the entirety of the composition. Therefore, the fluidity of the resin composition is lowered, and the surface roughness of the resultant molded product is increased. In addition, the carbon particles tend to be removed from the surface of the molded product, and thus the particles become a major cause of contamination.

When heated at 80° C. for 30 minutes, the resin (B) employed in the present invention generates gases in a total amount of 5 ppm or less, preferably 3 ppm or less. The resin (B) has a percentage of water absorption of 0.2% or less, preferably 0.15% or less.

Examples of the resin (B) include aliphatic polyolefins such as polyethylene, polypropylene, polybutene and polymethylpentene; and non-olefin resins such as aromatic polycarbonate, polybutylene terephthalate, polyethylene terephthalate, polyphenylene sulfide, polyether-imide, polysulfone, polyether-sulfone, polyether-ether-ketone, acrylic resin, styrenic resin, modified polyphenylene ether and liquid-crystalline polyester. Particularly in the case where the resultant molded product must be subjected to washing or thermal drying, from the viewpoint of physical properties, modified polyphenylene ether, polycarbonate and polyether-ether-ketone are preferred, and, from the economical viewpoint, polypropylene or the like is preferred.

Examples of the inorganic filler (C) which may be employed in the present invention include talc, calcium carbonate, barium sulfate, potassium titanate, clay, hydrotalcite, smectite, zinc oxide, silicon oxide, iron oxide, zinc powder and iron powder. These inorganic fillers are employed singly or in combination of two or more species. The average particle size of the inorganic filler (C) to be employed is 100 μm or less, preferably 0.1 to 20 μm, more preferably 1 to 15 μm.

The inorganic filler (C) may be employed without any treatment. If desired, the inorganic filler may be subjected to surface treatment with, for example, a silane-, titanate-, aluminum- or phosphate-containing coupling agent.

The ratio by volume of the electrically conductive filler to the resin (B) and the inorganic filler (C) (i.e., (A1+A2)/(B+C)) is 0.5/99.5 to 12/88, preferably 1/99 to 10/90, more preferably 2/98 to 8/92. The ratio of B/C is 30/70 or higher, preferably 50/50 or higher, more preferably 75/25 or higher. The electrically conductive resin composition of the present invention, which is formed through kneading of the aforementioned components, preferably has a notched IZOD impact strength of more than 0.05 J/m.

The electrically conductive resin composition can be produced by a method in which the aforementioned components are melt-kneaded by use of, for example, a generally employed extruder or kneader. In the production of the resin composition, the fine carbon particles or the inorganic filler may be added to the melt-kneaded resin components by a side feeding method or a compactor, or all the components may be charged to an extruder or a kneader at one time.

The thus-produced resin composition can be molded into a tray having a predetermined shape by various methods of thermoplastic resin molding. Specific examples of the molding methods include press molding, extrusion, vacuum molding, blow molding and injection molding.

### BEST MODE FOR CARRYING OUT THE INVENTION

The present invention will next be described in more detail with reference to Examples and Comparative Examples. The methods for evaluating vapor grown carbon fiber employed in the present invention and a resin composition containing the carbon fiber are described below.

[Raw Material]

Vapor Grown Carbon Fiber A:

Now will be described the method for preparing vapor grown carbon fiber A employed in Examples, and characteristic features of the carbon fiber. Benzene, ferrocene and sulfur were mixed together in proportions by mass of 91:7:2, to thereby prepare a liquid raw material. By use of a hydrogen carrier gas, the liquid raw material was sprayed to a reaction furnace (inner diameter: 100 mm, height: 2,500 mm) which had been heated to 1,200° C. In this case, the feed amount of the raw material was regulated to 10 g/min, and the flow rate of the hydrogen gas was regulated to 60 L/min. The thus-obtained reaction product (150 g) was charged into a graphite-made crucible (inner diameter: 100 mm, height: 150 mm), and baked in an argon atmosphere at 1,000° C. for one hour, followed by graphitization in an argon atmosphere at 2,800° C. for one hour, to thereby prepare vapor grown carbon fiber A.

The average diameter of the vapor grown carbon fiber was determined by observing the carbon fiber under a scanning electron microscope or a transmission electron microscope in 30 visual fields, and measuring the diameters of 300 filaments of the carbon fiber by use of an image analyzer (LUZEX-AP, product of Nireco Corporation). Similar to the case of the average fiber diameter, the average length of the carbon fiber was determined by observing the carbon fiber under a scanning electron microscope or a transmission electron microscope in 10×10 visual fields, and measuring the lengths of 300 filaments of the carbon fiber by use of the image analyzer. The aspect ratio was determined by dividing the average fiber length by the average fiber diameter. The branching degree of the carbon fiber was determined by dividing the number of branching points of one fiber filament by the length of the fiber filament. The BET specific surface area was measured by means of a nitrogen gas adsorption method employing a NOVA 1000 apparatus (product of Yuasa Ionics Inc.). The d₀₀₂ was measured by means of powder X-ray diffractometry by use of a Geigerflex apparatus (product of Rigaku Corporation) employing Si serving as an internal standard.

Vapor grown carbon fiber A was found to have an average fiber diameter of 150 nm, an average fiber length of 9 μm, a branching degree of 0.2 points/μm, an aspect ratio of 60, a BET specific surface area of 13 m²/g and a d₀₀₂ of 0.339 nm.

Vapor Grown Carbon Fiber B:

Now will be described the method for preparing vapor grown carbon fiber B employed in Examples, and characteristic features of the carbon fiber. Benzene, ferrocene and sulfur were mixed together in proportions by mass of 97:2:1, to thereby prepare a liquid raw material. By use of a hydrogen carrier gas, the liquid raw material was sprayed to a reaction furnace (inner diameter: 100 mm, height: 2,500 mm) which had been heated to 1,200° C. In this case, the feed amount of the raw material was regulated to 5 g/min and the flow rate of the hydrogen gas was regulated to 90 L/min.

The thus-obtained reaction product (150 g) was charged into a graphite-made crucible (inner diameter: 100 mm, height: 150 mm), and baked in an argon atmosphere at 1,000° C. for one hour, followed by graphitization in an argon atmosphere at 2,800° C. for one hour, to thereby prepare vapor grown carbon fiber B.

Vapor grown carbon fiber B was found to have an average fiber diameter of 80 nm, an average fiber length of 12 μm, an aspect ratio of 150, a BET specific surface area of 25 m²/g and a d₀₀₂ of 0.340 nm.

Vapor Grown Carbon Fiber C:

Now will be described the method for preparing vapor grown carbon fiber C employed in Comparative Examples, and characteristic features of the carbon fiber. Benzene, ferrocene and thiophene were mixed together in proportions by mass of 97:2:1, to thereby prepare a liquid raw material. By use of a hydrogen carrier gas, the liquid raw material was sprayed to a reaction furnace (inner diameter: 100 mm, height: 2,500 mm) which had been heated to 1,150° C. In this case, the feed amount of the raw material was regulated to 2 g/min, and the flow rate of the hydrogen gas was regulated to 180 L/min.

The thus-obtained reaction product (50 g) was charged into a graphite-made crucible (inner diameter: 100 mm, height: 150 mm) and baked in an argon atmosphere at 1,000° C. for one hour, followed by graphitization in an argon atmosphere at 2,800° C. for one hour, to thereby prepare vapor grown carbon fiber C.

Vapor grown carbon fiber C was found to have an average fiber diameter of 10 nm, an average fiber length of 12 μm, an aspect ratio of 1,200, a BET specific surface area of 200 m²/g and a d₀₀₂ of 0.343 nm.

Vapor Grown Carbon Fiber D:

Now will be described the method for preparing vapor grown carbon fiber D employed in Comparative Examples, and characteristic features of the carbon fiber. Benzene, ferrocene and sulfur were mixed together in proportions by mass of 88:10:2, to thereby prepare a liquid raw material. By use of a hydrogen carrier gas, the liquid raw material was sprayed to a reaction furnace (inner diameter: 100 mm, height: 2,500 mm) which had been heated to 1,150° C. In this case, the feed amount of the raw material was regulated to 15 g/min, and the flow rate of the hydrogen gas was regulated to 60 L/min.

The thus-obtained reaction product (150 g) was charged into a graphite-made crucible (inner diameter: 100 mm, height: 150 mm), and baked in an argon atmosphere at 1,000° C. for one hour, followed by graphitization in an argon atmosphere at 2, 800° C. for one hour, to thereby prepare vapor grown carbon fiber D.

Vapor grown carbon fiber D was found to have an average fiber diameter of 200 nm, an average fiber length of 4 μm, an aspect ratio of 20, a BET specific surface area of 11 m²/g and a d₀₀₂ of 0.338 nm.

Vapor Grown Carbon Fiber E:

Now will be described the method for preparing vapor grown carbon fiber E employed in Comparative Examples, and characteristic features of the carbon fiber. Reaction was performed under conditions similar to those for preparing vapor grown carbon fiber A. That is, benzene, ferrocene and sulfur were mixed together in proportions by mass of 91:7:2, to thereby prepare a liquid raw material, and subsequently, by use of a hydrogen carrier gas, the liquid raw material was sprayed to a reaction furnace (inner diameter: 100 mm, height: 2,500 mm) which had been heated to 1,200° C. In this case, the feed amount of the raw material was regulated to 10 g/min, and the flow rate of the hydrogen gas was regulated to 60 L/min.

The thus-obtained reaction product (150 g) was charged into a graphite-made crucible (inner diameter: 100 mm, height: 150 mm), and baked in an argon atmosphere at 1,000° C. for one hour, to thereby prepare vapor grown carbon fiber E without graphitization treatment.

Vapor grown carbon fiber E was found to have an average fiber diameter of 150 nm, an average fiber length of 9 μm, a branching degree of 0.2 points/μm, an aspect ratio of 60, a BET specific surface area of 14 m²/g and a d₀₀₂ of 0.348 nm.

Table 1 shows the measured data of the above-prepared vapor grown carbon fibers.

TABLE 1

| | | Interlayer | | |
|---|---|---|---|---|
| | Fiber outer | spacing | | BET specific |
| Vapor grown | diameter | d₀₀₂ | Aspect | surface area |
| carbon fiber | (nm) | (nm) | ratio | (m²/g) |
| A | 150 | 0.339 | 60 | 13 |
| B | 150 | 0.340 | 150 | 25 |
| C | 10 | 0.343 | 1200 | 200 |
| D | 200 | 0.338 | 20 | 11 |
| E | 150 | 0.348 | 60 | 14 |

Physical properties of a resin composition were measured by means of the below-described methods.

a) Volume resistivity: measured in accordance with the four-probe method by use of Loresta HP MCP-T410 (product of Mitsubishi Chemical Corporation).

b) Thermal deformation temperature: measured by means of the method specified by ASTM D648 under application of a small amount of load (0.45 MPa).

c) Percentage of water absorption of resin composition: a test piece formed of a resin composition was immersed in distilled water of 23° C. for 24 hours, and the ratio of an increase in the mass of the test piece to the mass of the test piece before the water immersion (i.e., percentage of water absorption) was calculated.

d) Evaluation of the amount of generated gases: a resin composition (1 g) was placed in a stream of nitrogen gas at 80° C. for 30 minutes; organic substances thermally removed from the composition were temporarily trapped in a column filled with an adsorbent (N5020, product of Sigma Aldrich Japan K.K.); the thus-trapped organic substances were thermally desorbed from the adsorbent and concentrated by use of an injection apparatus having a cooling trap; and the thus-concentrated organic substances were injected into a gas chromatography-mass spectrometer (GC-MS) (GCMS-QP1000EX, product of Shimadzu Corporation, column: DB-1 (0.53 mm×30 m, film thickness: 0.1 μm, product of Shimadzu Corporation)).

The organic substances thermally released from the resin composition were separated from one another and subjected to chemical structure analysis by use of the GC-MS, followed by quantification of the released organic substances. The total of the masses of the thus-detected organic substances was calculated on a toluene mass basis, and the thus-calculated value was regarded as the total amount of generated gases.

e) Evaluation of particle contamination: one sample sheet was immersed in pure water (500 mL) under application of ultrasonic waves (40 KHz, 0.5 W/cm²) for 60 seconds. Thereafter, an aliquot of the resultant pure water was sampled by suction by means of a liquid particle counter, and the size and number of particles contained in the sampled portion were measured. Particle contamination of the sample was graded as follows according to the number of particles having a diameter of 1 μm or more: “◯” when the number is less than 1,000 pcs/cm², “Δ” when the number is 1,000 pcs/cm² or more and less than 5,000 pcs/cm², and “x” when the number is 5,000 pcs/cm² or more.

### EXAMPLE 1

Modified PPE (AV80, product of Mitsubishi Engineering-Plastics Corporation) (85 mass %) and vapor grown carbon fiber A (15 mass %, 8.1 vol %) were melt-kneaded by use of Labo Plastomill (product of Toyo Seiki Seisaku-Sho, Ltd.) at 240° C. and 80 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 250° C. and 200 kgf/cm² for 30 seconds.

### EXAMPLE 2

Polycarbonate resin (Iupilon H4000, product of Mitsubishi Gas Chemical Company, Inc.) (90 mass %) and vapor grown carbon fiber B (10 mass %, 5.3 vol %) were melt-kneaded by use of Labo Plastomill (product of Toyo Seiki Seisaku-Sho, Ltd.) at 240° C. and 80 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 250° C. and 200 kgf/cm² for 30 seconds.

### EXAMPLE 3

Polycarbonate resin (Iupilon H4000, product of Mitsubishi Gas Chemical Company, Inc.) (87 mass %), vapor grown carbon fiber A (10 mass %, 5.3 vol %), and Ketjen Black (EC600ID, product of Lion Akzo Co., Ltd., particle size: 30 nm, aspect ratio: 1) (3 mass %, 1.7 vol %) were melt-kneaded by use of Labo Plastomill (product of Toyo Seiki Seisaku-Sho, Ltd.) at 240° C. and 80 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 250° C. and 200 kgf/cm² for 30 seconds.

### EXAMPLE 4

Polypropylene resin (PW201N: MI=0.5 g/10 min, product of SunAllomer Ltd.) (50 mass %), vapor grown carbon fiber A (10 mass %, 6.5 vol %), and aminosilane-treated glass beads having a particle size of 20 μm (EGB-731, product of Potters-Ballotini Co., Ltd.) (40 mass %) were melt-kneaded by use of Labo Plastomill (product of Toyo Seiki Seisaku-Sho, Ltd.) at 240° C. and 40 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 180° C. and 200 kgf/cm² for 30 seconds.

### COMPARATIVE EXAMPLE 1

Polycarbonate resin (Iupilon H4000, product of Mitsubishi Gas Chemical Company, Inc.) (90 mass %) and vapor grown carbon fiber C (10 mass %, 5.3 vol %) were melt-kneaded by use of Labo Plastomill (product of Toyo Seiki Seisaku-Sho, Ltd.) at 240° C. and 80 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 250° C. and 200 kgf/cm² for 30 seconds.

When carbon fiber having a diameter of 10 nm and an aspect ratio of 1,200 (i.e., thin and long carbon fiber) is employed, filaments of the carbon fiber tend to aggregate to one another, and the aggregating carbon fiber filaments are difficult to uniformly disperse in a resin. Therefore, it develops difficulty in forming an electrically conductive network due to uneven distribution of the aggregating filaments in the resin, and thus addition of a small amount of the carbon fiber failed to attain a target electrical resistance.

### COMPARATIVE EXAMPLE 2

Polycarbonate resin (Iupilon H4000, product of Mitsubishi Gas Chemical Company, Inc.) (85 mass %) and vapor grown carbon fiber D (15 mass %, 8.1 vol %) were melt-kneaded by use of Labo Plastomill (product of Toyo Seiki Seisaku-Sho, Ltd.) at 240° C. and 80 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 250° C. and 200 kgf/cm² for 30 seconds.

Carbon fiber having an aspect ratio of 20 (i.e., short carbon fiber) can be uniformly dispersed in a resin, but fails to provide an effective electrically conductive network. Therefore, addition of the carbon fiber in an amount of 25 mass % (14.3 vol %) or more is required for attaining a target electrical resistance (10⁵ Ωcm or less). Thus, when a large amount of the carbon fiber is added to a resin, the moldability of the resultant resin composition is deteriorated, and mechanical characteristics (in particular, tensile strength and elongation) of a molded product produced from the composition are considerably deteriorated.

### COMPARATIVE EXAMPLE 3

Polycarbonate resin (Iupilon H4000, product of Mitsubishi Gas Chemical Company, Inc.) (80 mass %) andvapor grown carbon fiber E (20 mass %, 11.1 vol %) were melt-kneaded by use of Labo Plastomill (product of Toyo Seiki Seisaku-Sho, Ltd.) at 240° C. and 80 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 250° C. and 200 kgf/cm² for 30 seconds.

When carbon fiber having a d₀₀₂ of 0.348 nm (i.e., carbon fiber of low crystallinity) is employed, the activation energy of electron transfer which is caused by contact between filaments of the carbon fiber or by a tunnel effect increases, which makes electron transfer difficult. Therefore, the resultant resin composition exhibits increased volume resistivity; i.e., difficulty is encountered in attaining high electrical conductivity of the resin composition.

### COMPARATIVE EXAMPLE 4

Polycarbonate resin (Iupilon H4000, product of Mitsubishi Gas Chemical Company, Inc.) (90 mass %) and polyacrylonitrile-based carbon fiber filaments which are bound with epoxy resin (HTAC6SRS, product of Toho Tenax Co., Ltd., the outer diameter and length of each fiber filament are 7 μm and 6 mm, respectively) (10 mass %, 5.8 vol %) were melt-kneaded by use of Labo Plastomill (product of Toyo Seiki Seisaku-Sho, Ltd.) at 240° C. and 80 rpm for 10 minutes. Subsequently, the thus-kneaded product was molded into a plate having dimensions of 10 mm×10 mm×2 mmt by use of a 50-ton thermal molding machine (product of Nippo Engineering Co., Ltd.) at 250° C. and 200 kgf/cm² for 30 seconds.

When carbon fiber filaments bound with a binder such as epoxy resin are employed, the binder may generate organic contamination gases, which is not preferred.

TABLE 2

| | | | Thermal | Percentage | Amount of | |
|---|---|---|---|---|---|---|
| | Ratio by volume | Volume | deformation | of water | generated | Particle |
| | of fiber to resin | resistivity | temperature | absorption | gases | contamina- |
| | (vol %) | (Ωcm) | (° C.) | (%) | (ppm) | tion |
| Ex. 1 | Fiber A/resin*¹ | 5.8 × 10³ | 150 | 0.12 | 1.1 | ∘ |
| | 8.1 | | | | | |
| Ex. 2 | Fiber B/resin*² | 2.3 × 10³ | 150 | 0.13 | 1.5 | ∘ |
| | 5.3 | | | | | |
| Ex. 3 | Fiber A + | 3.3 × 10¹ | 140 | 0.12 | 1.9 | Δ |
| | α*³/resin*² | | | | | |
| | 5.3 | | | | | |
| Ex. 4 | Fiber A/resin + | 3.3 × 10² | 145 | 0.05 | 2.8 | ∘ |
| | β*⁴ | | | | | |
| | 6.5 | | | | | |
| Comp. | Fiber C/resin*² | 1.2 × 10⁶ | 155 | 0.11 | 1.2 | Δ |
| Ex. 1 | 5.3 | | | | | |
| Comp. | Fiber D/resin*² | 1.8 × 10⁹ | 150 | 0.11 | 1.3 | Δ |
| Ex. 2 | 8.1 | | | | | |
| Comp. | Fiber E/resin*² | 4.1 × 10⁷ | 145 | 0.14 | 5.2 | ∘ |
| Ex. 3 | 11.1 | | | | | |
| Comp. | Acrylic | 5.0 × 10³ | 150 | 0.21 | 6.0 | ∘ |
| Ex. 4 | fiber resin*² | | | | | |
| | 5.8 | | | | | |

Note)
*¹Modified PPE resin
*²Polycarbonate resin
*³Ketjen black
*⁴Aminosilane-treated glass beads

### INDUSTRIAL APPLICABILITY

When a container for transporting electronics-related parts or semiconductor-related parts, or a packaging material, is produced from the electrically conductive resin composition of the present invention, which contains vapor grown carbon fiber and a resin that generates only a small amount of gas, generation of moisture or an organic gas from the container (carrier) can be suppressed during the course of storage or transportation of an IC chip, wafer or hard disk employed in an electronic device, deposition of such a gas onto the surface of the device can be prevented, lowering of the yield or quality of a final product can be prevented, and the reliability of the product can be enhanced. The electrically conductive resin composition of the present invention exhibits excellent electrical conductivity and causes much less contamination, which is incurred by volatile substances or removed particles from the composition. Therefore, the resin composition is suitable for use in an antistatic material or an electrically conductive material, particularly in a material for packaging electronic parts or a container for transporting electronic parts (e.g., a box for IC parts, a box for storing circuits, an IC tray, an IC carrier tape, a hard disk casing or a silicon wafer casing). The container for transporting a hard disk head of the present invention causes much less contamination to the surface of a hard disk head; i.e., the container hardly raises problems due to contamination. In addition, the container exhibits excellent electrical conductivity, antistatic property, mechanical strength and heat resistance and therefore the container has very high industrial utility value.

1. An electrically conductive resin composition comprising a vapor grown carbon fiber (A1) having an outer fiber diameter of 80 to 500 nm; and a resin (B), characterized in that:
(1) the vapor grown carbon fiber (A1) has an interlayer spacing (d₀₀₂) of 0.345 nm or less and an aspect ratio of 40 to 1,000,
(2) the ratio by volume of the vapor grown carbon fiber (A1) to the resin (B) (i.e., A1/B) is 0.5/99.5 to 12/88,
(3) the electrically conductive resin composition has a volume resistivity value of 10⁵ Ωcm or less, and
(4) when the resin composition is heated at 80° C. for 30 minutes, the total amount of gases generated therefrom is 5 ppm or less.

2. An electrically conductive resin composition comprising an electrically conductive filler containing a vapor grown carbon fiber (A1) having an outer fiber diameter of 80 to 500 nm, and fine carbon particles (A2); and a resin (B), characterized in that:
(1) the electrically conductive filler consists of the vapor grown carbon fiber (A1) having an interlayer spacing (d₀₀₂) of 0.345 nm or less and an aspect ratio of 40 to 1,000, and the fine carbon particles (A2) having a minor axis diameter of 1 to 500 nm and an aspect ratio of 5 or less,
(2) the ratio by volume of the electrically conductive filler to the resin (B) (i.e., (A1+A2)/B) is 0.5/99.5 to 12/88,
(3) the electrically conductive resin composition has a volume resistivity value of 10⁵ Ωcm or less, and
(4) when the resin composition is heated at 80° C. for 30 minutes, the total amount of gases generated therefrom is 5 ppm or less.

3. The electrically conductive resin composition according to claim 2, wherein the ratio by mass of the vapor grown carbon fiber (A1) to the fine carbon particles (A2) (i.e., A1/A2) is 5/95 to 95/5.

4. An electrically conductive resin composition comprising an electrically conductive filler containing a vapor grown carbon fiber (A1) having an outer fiber diameter of 80 to 500 nm, and fine carbon particles (A2); a resin (B); and an inorganic filler (C) having a particle size of 100 μm or less, characterized in that:
(1) the electrically conductive filler consists of the vapor grown carbon fiber (A1) having an interlayer spacing (d₀₀₂) of 0.345 nm or less and an aspect ratio of 40 to 1,000, and the fine carbon particles (A2) having a minor axis diameter of 1 to 500 nm and an aspect ratio of 5 or less,
(2) the ratio by volume of the electrically conductive filler to the resin (B) and the inorganic filler (C) (i.e., (A1+A2)/(B+C)) is 0.5/99.5 to 12/88,
(3) the electrically conductive resin composition has a volume resistivity value of 10⁵ Ωcm or less, and
(4) when the resin composition is heated at 80° C. for 30 minutes, the total amount of gases generated therefrom is 5 ppm or less.

5. The electrically conductive resin composition according to claim 1, wherein the resin (B) contains at least one species selected from among polyethylene, polypropylene, polybutene, polymethylpentene, alicyclic polyolefin, aromatic polycarbonate, polybutylene terephthalate, polyethylene terephthalate, polyphenylene sulfide, polyether-imide, polysulfone, polyether-sulfone, polyether-ether-ketone, acrylic resin, styrenic resin, modified polyphenylene ether and liquid-crystalline polyester.

6. The electrically conductive resin composition according to claim 5, wherein the resin (B) contains at least one species selected from among polypropylene, aromatic polycarbonate, polyether-ether-ketone and modified polyphenylene ether.

7. The electrically conductive resin composition according to claim 1, wherein the vapor grown carbon fiber (A1) has a BET specific surface area of 4 to 30 m²/g.

8. The electrically conductive resin composition according to claim 1, wherein a percentage of water absorption is 0.2% or less, when immersed in distilled water of 23° C. for 24 hours.

9. A resin molded product comprising the electrically conductive resin composition described in claim 1.

10. The resin molded product according to claim 9, which is a container or a packaging material for an electronic part.

11. The resin molded product according to claim 9, which is a container for transporting a semiconductor part or a hard disk.

12. The resin molded product according to claim 11, wherein the container for transporting a hard disk is employed for a hard disk head.
